(19) United States
(12) Patent Application Publication
(10) Pub. No.: US 2021/0406463 A1
(43) Pub. Date: Dec. 30, 2021

(54) INTENT DETECTION FROM MULTILINGUAL AUDIO SIGNAL

(71) Applicant: ANI TECHNOLOGIES PRIVATE LIMITED, Bengaluru (IN)

(72) Inventors: Sanjay Bhutungru, Mohali (IN); Rajesh Kumar Singh, Bokaro (IN); Yugandhar Nanda, Srikakulam (IN)

(73) Assignee: ANI TECHNOLOGIES PRIVATE LIMITED, Bengaluru (IN)

(21) Appl. No.: 17/190,783

(22) Filed: Mar. 3, 2021

(30) Foreign Application Priority Data
Jun. 25, 2020 (IN) 202041026989

(51) Int. Cl. G06F 40/226; G06F 40/263; G06F 40/284; G06F 40/295; G06F 40/242

(52) U.S. Cl. CPC G06F 40/226; G06F 40/263; G06F 40/242; G06F 40/295; G06F 40/284

(57) ABSTRACT

A method and system for user's intent detection is provided. An audio signal, which is a spoken operation command from a user, is received by an NLP. The audio signal is a multilingual audio signal. The multilingual audio signal is then converted into a text component for each of a plurality of language transcripts. A plurality of tokens is generated for the text component of each of the plurality of language transcripts. The plurality of tokens is validated using a language transcript dictionary associated with a respective language transcript. One of entity, keyword, and action features is detected from the tokens. One or more intents are determined, and an intent is selected from the one or more intents based on an intent score of each intent. Based on the selected intent, an operation is automatically executed.

### CROSS-RELATED APPLICATIONS

This application claims priority of Indian Non-Provisional Application No. 202041026989, filed Jun. 25, 2020, the contents of which are incorporated herein by reference.

### FIELD

Various embodiments of the disclosure relate generally to speech recognition systems. More specifically, various embodiments of the disclosure relate to intent detection from a multilingual audio signal.

### BACKGROUND

Speech recognition is identification of spoken words by a computer using speech recognition programs. The speech recognition programs enable the computer to understand and process information communicated verbally by a human user. These programs significantly minimize laborious process of entering such information into the computer by typewriting. Various speech recognition programs are well known in the art. Generally, in speech recognition, the spoken words are converted into text. Here, conventional speech recognition programs are useful in automatically converting speech into text. Based on the converted text, the computer identifies an action item associated with the spoken words and thereafter, executes the action item.

Generally, individuals, from different parts of the world, speak different languages. In some specific scenarios, an individual may communicate in multiple languages at the same time. Also, the individual may mix-up the multiple languages at the same time to convey a message. The current speech recognition systems are trained to detect an action item based on a speech signal in a single language. Thus, the current speech recognition systems fail to identify action items from the speech signal when the speech signal corresponds to a conversation or a command that is a mixture of multiple languages. For example, now-a-days, availing cab services have become an easy way to commute from one location to another location. A passenger travelling in a cab may belong to a different geographical region and may have specific language preferences that are different from a driver of the cab. Further, the passenger and the driver may not speak and understand the languages of each other. In such a scenario, it becomes difficult for the passenger to convey preferences (related to media content, locations, or the like) to the driver during the ride. As a result, the passenger and the driver may not experience a good ride, which can reduce the footprints of potentials passengers that may not be desirable for a cab service provider offering cab services to the passengers. Thus, there is a need for a speech recognition system that can understand different languages at the same time and execute one or more related action items.

Currently, most of the speech recognition systems process speech signals by searching for spoken words in language dictionaries, so that the source language can be recognized. But with thousands of languages, the creation of these dictionaries is quite time consuming Some existing speech recognition systems provide solutions by creating training models or mathematical expressions for every language. But the collection of training data for so many different languages is incredibly difficult. In light of the foregoing, there exists a need for a technical and reliable solution that overcomes the above-mentioned problems, challenges, and short-comings, and continues to detect one or more intents from a speech signal in multiple languages.

### SUMMARY

Intent detection from a multilingual audio signal is provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a system environment for intent detection from a multilingual audio signal, in accordance with an exemplary embodiment of the disclosure;

FIG. 2 is a block diagram that illustrates an application server of the system environment of FIG. 1, in accordance with an exemplary embodiment of the disclosure;

FIG. 3 is a block diagram that illustrates a chatbot device of a vehicle of the system environment of FIG. 1, in accordance with an exemplary embodiment of the disclosure;

FIGS. 4A and 4B, collectively, is a block diagram that illustrate an exemplary scenario for intent detection from the multilingual audio signal, in accordance with an exemplary embodiment of the disclosure;

FIGS. 5A and 5B, collectively, is a diagram that illustrates a flow chart of a method for detecting an intent from the multilingual audio signal, in accordance with an exemplary embodiment of the disclosure; and

FIG. 6 is a block diagram that illustrates a system architecture of a computer system for detecting the intent from the multilingual audio signal, in accordance with an exemplary embodiment of the disclosure.

### DETAILED DESCRIPTION

Certain embodiments of the disclosure may be found in a disclosed apparatus for intent detection. Exemplary aspects of the disclosure provide a method and a system for detecting one or more intents from a multilingual audio signal. The method includes one or more operations that are executed by circuitry of a natural language processor (NLP) of an application server or a vehicle chatbot device to detect the one or more intents from the multilingual audio signal. The circuitry may be configured to generate the multilingual audio signal based on utterance by a user to initiate an operation. The multilingual audio signal may be representation of audio or sound including one or more packets of words uttered by the user in a plurality of languages. The circuitry may be further configured to convert the multilingual audio signal into a text component for each of a plurality of language transcripts corresponding to the plurality of languages. The circuitry may be further configured to generate a plurality of tokens for the text component of each of the plurality of language transcripts. The circuitry may be further configured to validate the plurality of tokens corresponding to each of the plurality of language transcripts. The plurality of tokens may be validated by using a language transcript dictionary associated with a respective language transcript. Based on validation of the plurality of tokens, the circuitry may obtain a set of validated tokens.

The circuitry may be further configured to generate a set of valid multilingual sentences based on at least the set of validated tokens and positional information of each validated token. The circuitry may be further configured to determine an entity feature based on at least the set of valid multilingual sentences and an entity index by using phonetic matching and prefix matching. The circuitry may be further configured to determine the keyword and action features based on at least the set of validated tokens by using a filtration database including at least a set of validated entity, keyword, and action features for each stored intent. The circuitry may be further configured to determine one or more intents based on at least one of the determined entity, keyword, and action features. The circuitry may be further configured to determine an intent score for each determined intent. The intent score may be determined based on at least the determined entity, keyword, and action features. The circuitry may be further configured to select an intent from the one or more intents based on the intent score of each of the one or more intents. The intent score of the selected intent may be greater than the intent score of each of remaining intents of the one or more intents. Upon selection of the intent, the circuitry may be further configured to execute the operation requested by the user based on the selected intent. The operation may correspond to an in-vehicle feature or service associated with infotainment, air-conditioning, ventilation, or the like.

Various methods and systems of the disclosure facilitate intent detection from the multilingual audio signal. The user can use multilingual sentences to provide commands or instructions in order to execute one or more operations. The disclosed methods and systems provide ease for controlling and managing various infotainment-related features or services inside the vehicle. The disclosed methods and systems further provide ease for controlling and managing heating, ventilation, and air conditioning (HVAC) inside the vehicle. The disclosed methods and systems further provide ease for monitoring, controlling, operating door settings, window settings, safety equipment (e.g., airbag deployment control unit, collision sensor, nearby object sensing system, seat belt control unit, sensors for setting the seat belt, or the like), wireless network sensor (e.g., wireless fidelity (Wi-Fi) or Bluetooth sensors), head lights, display panels, or the like.

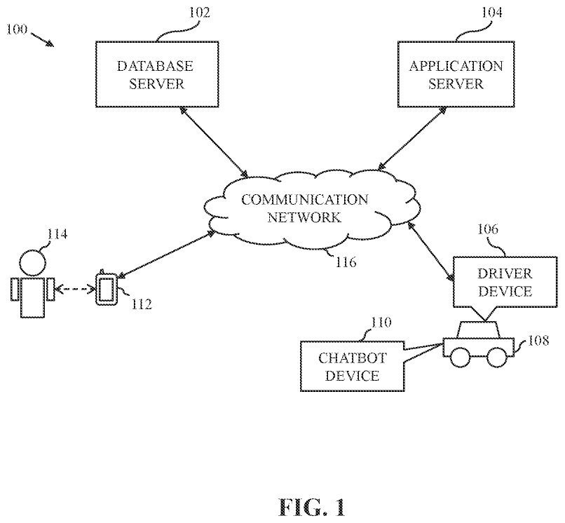

FIG. 1 is a block diagram that illustrates a system environment 100 for intent detection from a multilingual audio signal, in accordance with an exemplary embodiment of the disclosure. The system environment 100 includes circuitry such as a database server 102, an application server 104, a driver device 106 of a vehicle 108, a chatbot device 110 installed inside the vehicle 108, and a user device 112 of a user 114. The database server 102, the application server 104, the driver device 106, the chatbot device 110, and the user device 112 may be communicatively coupled to each other via a communication network 116.

The database server 102 may include suitable logic, circuitry, interfaces, and/or code, executable by the circuitry, that may be configured to perform one or more operations, such as receiving, storing, processing, and transmitting queries, signals, messages, data, or content. The database server 102 may be a data management and storage computing device that is communicatively coupled to the application server 104, the driver device 106, the chatbot device 110, and the user device 112 via the communication network 116 to perform the one or more operations. Examples of the database server 102 may include, but are not limited to, a personal computer, a laptop, or a network of computer systems.

In an embodiment, the database server 102 may be configured to manage and store user information of each user (such as the user 114), driver information of each driver (such as a driver of the vehicle 108), and vehicle information of each vehicle (such as the vehicle 108). For example, the user information of each user may include at least a user name, a user contact number, or a user unique identifier (ID), along with other information pertaining to a user account of each user registered with an online service provider such as a cab service provider. Further, the driver information of each driver may include at least a driver name, a driver ID, and a registered vehicle make, along with other information pertaining to a driver account of each driver registered with the cab service provider. Further, the vehicle information of each vehicle may include at least a vehicle type, a vehicle number, a vehicle chassis number, or the like. In an embodiment, the database server 102 may be configured to generate a tabular data structure including one or more rows and columns and store the user, driver, and/or vehicle information in a structured manner in the tabular data structure. For example, each row of the tabular data structure may be associated with the user 114 having a unique user ID, and one or more columns corresponding to each row may indicate the various user information of the user 114.

In an embodiment, the database server 102 may be further configured to manage and store preferences of the user 114 such as a driver of the vehicle 108 or a passenger of vehicle 108. The preferences may be associated with one or more languages, multimedia content, in-vehicle temperature, locations (such as pick-up and drop-off locations), or the like. In an embodiment, the database server 102 may be further configured to manage and store a language transcript dictionary for each of a plurality of language transcripts corresponding to each of a plurality of languages associated with a geographical region such as a village, a town, a city, a state, a country, or the like. A language transcript may correspond to a language such as Hindi, English, Tamil, Telugu, Punjabi, Bengali, Kannada, Sanskrit, French, Spanish, Urdu, or the like. The language transcript dictionary of each language transcript may include one or more sets of dictionary words that are valid with respect to the respective language transcript. For example, the language transcript dictionary may include one or more words, such as one or more entity-related, action-related, keyword-related, event-related, situation-related, change-related words, or the like, that are valid with respect to a language such as Hindi, English, Tamil, Telugu, Punjabi, Bengali, Kannada, Sanskrit, French, Spanish, Urdu, or the like.

In an embodiment, the database server 102 may be further configured to manage and store historical audio signals of various users who are associated with one or more vehicles (such as the vehicle 108) offered by the cab service provider for ride-hailing services. The database server 102 may be further configured to manage and store a textual interpretation or representation of each historical audio signal. The textual interpretation or representation may include one or more packets of one or more words in one or more languages associated with each historical audio signal.

In an embodiment, the database server 102 may be further configured to receive one or more queries from the application server 104 or the chatbot device 110 via the communication network 116. Each query may be an encrypted message that is decoded by the database server 102 to determine one or more requests for retrieving requisite information (such as the vehicle information, the driver information, the user information, the language transcript dictionary, or any combination thereof). In response to the received queries, the database server 102 may be configured to retrieve and transmit the requested information to the application server 104 or the chatbot device 110 via the communication network 116.

The application server 104 may include suitable logic, circuitry, interfaces, and/or code, executable by the circuitry, that may be configured to perform one or more operations associated with the intent detection based on the multilingual audio signal. The application server 104 may be a computing device, which may include a software framework, that may be configured to create the application server implementation and perform the various operations associated with the intent detection. The application server 104 may be realized through various web-based technologies, such as, but are not limited to, a Java web-framework, a .NET framework, a professional hypertext pre-processor (PHP) framework, a python framework, or any other web-application framework. The application server 104 may also be realized as a machine-learning model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the application server 104 may include, but are not limited to, a personal computer, a laptop, or a network of computer systems.

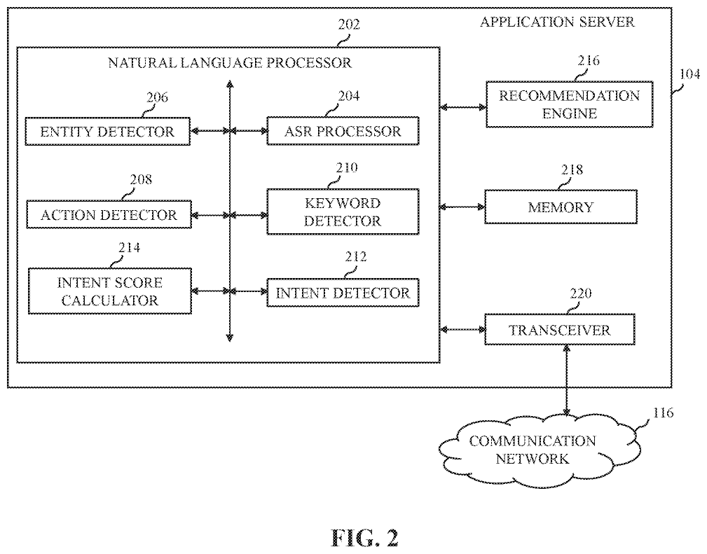

In an embodiment, the application server 104 may be configured to receive a multilingual audio signal from a vehicle device, such as the driver device 106 or the chatbot device 110, or the user device 112 via the communication network 116. The multilingual audio signal may include signal(s) corresponding to audio or sound uttered by the user 114 using the plurality of languages. The application server 104 may be further configured to covert the multilingual audio signal into a text component. The multilingual audio signal may be converted into the text component for each of the plurality of language transcripts corresponding to the plurality of languages. The application server 104 may be further configured to generate a plurality of tokens and validate the plurality of tokens to obtain a set of validated tokens. The application server 104 may be further configured to determine at least one of entity, keyword, and action features based on at least the set of validated tokens. The application server 104 may be further configured to detect one or more intents based on at least the determined entity, keyword, and action features. Further, the application server 104 may be configured to determine an intent score for each of the one or more intents. The application server 104 may be further configured to select an intent from the one or more intents based on the intent score of each of the one or more intents. Upon selection of the intent, the application server 104 may be further configured to automatically execute an operation associated with the multilingual audio signal. Various operations of the application server 104 have been described in detail in conjunction with FIGS. 2, 4A-4B, and 5A-5B.

The driver device 106 may include suitable logic, circuitry, interfaces, and/or code, executable by the circuitry, that may be configured to perform one or more operations associated with the intent detection. The driver device 106 may be a computing device that is utilized by the driver of the vehicle 108 to perform the one or more operations. For example, the driver device 106 may be utilized, by the driver, to input or update the driver or vehicle information by using a service application running on the driver device 106. The driver device 106 may be further utilized, by the driver, to input or update the preferences corresponding to the one or more languages, multimedia content, in-vehicle temperature, locations, ride types, log-in, log-out, or the like. The driver device 106 may be further utilized, by the driver, to view a navigation map and navigate across various locations using the navigation map. The driver device 106 may be further utilized, by the driver, to view allocation information such as current allocation information or future allocation information associated with the vehicle 108. The allocation information may include at least passenger information of a passenger (such as the user 114) and ride information of a ride including at least a ride time and a pick-up location associated with the ride initiated by the passenger. The driver device 106 may be further utilized, by the driver, to view the user information and the preferences of the user 114.

In an embodiment, the driver device 106 may be configured to detect utterance or sound produced by the user 114 (such as the passenger or the driver) in the vehicle 108. The utterance or sound may be detected by one or more microphones (not shown) integrated with the driver device 106. The driver device 106 may be further configured to generate the multilingual audio signal based on the utterance or sound produced by the user 114. Thereafter, the driver device 106 may be configured to transmit the multilingual audio signal to the application server 104 or the chatbot device 110 via the communication network 116.

In an embodiment, the driver device 106 may include one or more Global Positioning System (GPS) sensors (not shown) that are configured to detect and measure real-time position information of the driver device 106 and transmit the real-time position information to the database server 102 or the application server 104. In an exemplary embodiment, the real-time position information of the driver device 106 may be indicative of real-time position information of the vehicle 108. In an embodiment, the driver device 106 may be communicatively coupled to one or more in-vehicle devices or components associated with one or more in-vehicle systems, such as an infotainment system, a heating, ventilation, and air conditioning (HVAC) system, a navigation system, a power window system, a power door system, a sensor system, or the like, of the vehicle 108 via an in-vehicle communication mechanism such as an in-vehicle communication bus (not shown). The driver device 106 may be further configured to communicate one or more instructions or control commands to the one or more in-vehicle devices or components based on the multilingual audio signal.

In an embodiment, the driver device 106 may be further configured to transmit information, such as an availability status, a current booking status, a ride completion status, a ride fare, or the like, associated with the driver or the vehicle 108 to the database server 102 or the application server 104 via the communication network 116. In one example, such information may be automatically detected by the service application running on the driver device 106. In another example, the driver device 106 may be utilized, by the driver of the vehicle 108, to manually update the information after a regular interval of time or after completion of each ride. In an exemplary embodiment, the driver device 106 may be a vehicle head unit. In another exemplary embodiment, the driver device 106 may be an external communication device, such as a smartphone, a tablet computer, a laptop, or any other portable communication device, that is placed inside the vehicle 108.

The vehicle 108 is a mode of transport that is deployed by the cab service provider to offer on-demand vehicle or ride services to one or more passengers such as the user 114. The cab service provider may deploy the vehicle 108 for offering different types of rides, such as share-rides, non-share rides, rental rides, or the like, to the one or more passengers. Examples of the vehicle 108 may include, but are not limited to, an automobile, a bus, a car, and a bike. In one example, the vehicle 108 is a micro-type vehicle such as a compact hatchback vehicle. In another example, the vehicle 108 is a mini-type vehicle such as a regular hatchback vehicle. In another example, the vehicle 108 is a prime-type vehicle such as a prime sedan vehicle, a prime play vehicle, a prime sport utility vehicle (SUV), or a prime executive vehicle. In another example, the vehicle 108 is a lux-type vehicle such as a luxury vehicle.

In an embodiment, the vehicle 108 may include the chatbot device 110 for performing one or more operations associated with the intent detection. The vehicle 108 may further include the one or more in-vehicle devices or components associated with the one or more in-vehicle systems, such as the infotainment system, the HVAC system, the navigation system, the power window system, the power door system, the sensor system, or the like. The one or more in-vehicle systems may be communicatively coupled to the database server 102 or the application server 104 via the communication network 116. The one or more in-vehicle devices or components may also be communicatively coupled to the driver device 106 or the chatbot device 110 via the in-vehicle communication bus such as a controller area network (CAN) bus. The vehicle 108 may further include one or more Global Navigation Satellite System (GNSS) sensors (for example, GPS sensors) for detecting and measuring the real-time position information of the vehicle 108.

The chatbot device 110 may include suitable logic, circuitry, interfaces, and/or code, executable by the circuitry, that may be configured to perform one or more operations associated with the intent detection based on the multilingual audio signal. The chatbot device 110 may be a computing device, which may include a software framework, that may be configured to create an in-vehicle server implementation and perform the various operations associated with the intent detection. The chatbot device 110 may be realized through various web-based technologies, such as, but are not limited to, a Java web-framework, a .NET framework, a PHP framework, a python framework, or any other web-application framework. The chatbot device 110 may also be realized as a machine-learning model that implements any suitable machine-learning techniques, statistical techniques, or probabilistic techniques. Examples of such techniques may include expert systems, fuzzy logic, SVM, HMMs, greedy search algorithms, rule-based systems, Bayesian models (e.g., Bayesian networks), neural networks, decision tree learning methods, other non-linear training techniques, data fusion, utility-based analytical systems, or the like. Examples of the chatbot device 110 may include, but are not limited to, a personal computer, a laptop, or a network of computer systems.

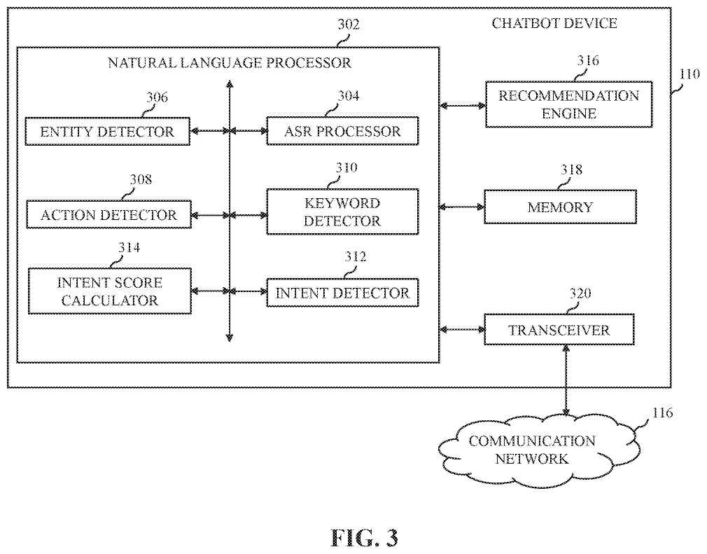

In an embodiment, the chatbot device 110 may be configured to receive the multilingual audio signal from a vehicle device, such as the driver device 106, or the user device 112 and covert the multilingual audio signal into the text component. The multilingual audio signal may be converted into the text component for each of the plurality of language transcripts corresponding to each of the plurality of languages. The chatbot device 110 may be further configured to generate the plurality of tokens and validate the plurality of tokens to obtain the set of validated tokens. The chatbot device 110 may be further configured to determine at least one of the entity, keyword, and action features based on at least the set of validated tokens. The chatbot device 110 may be further configured to detect the one or more intents based on at least one of the determined entity, keyword, and action features. Further, the chatbot device 110 may be configured to determine the intent score for each of the one or more intents. The chatbot device 110 may be further configured to select an intent from the one or more intents based on the intent score of each of the one or more intents. Upon selection of the intent, the chatbot device 110 may be further configured to automatically execute the operation associated with the multilingual audio signal. Various operations of the chatbot device 110 have been described in detail in conjunction with FIGS. 3, 4A-4B, and 5A-5B.

The user device 112 may include suitable logic, circuitry, interfaces, and/or code, executable by the circuitry, that may be configured to perform one or more operations. For example, the user device 112 may be a computing device that is utilized, by the user 114, to initiate the one or more operations by using a service application (associated with the cab service provider and hosted by the application server 104) running on the user device 112. The user device 112 may be utilized, by the user 114, to provide one or more operational commands to the database server 102, the application server 104, the driver device 106, or the chatbot device 110. The one or more operational commands may be provided by using a text-based input, a voice-based input, a gesture-based input, or any combination thereof. The one or more operational commands may be received from the user 114 for controlling and managing one or more in-vehicle features or services associated with the vehicle 108. In some embodiment, the user device 112 may be configured to generate the multilingual audio signal based on detection of the audio or sound uttered by the user 114. Thereafter, the user device 112 may communicate the multilingual audio signal to the application server 104 or the chatbot device 110. Examples of the user device 112 may include, but are not limited to, a personal computer, a laptop, a smartphone, a tablet computer, and the like.

The communication network 116 may include suitable logic, circuitry, interfaces, and/or code, executable by the circuitry, that may be configured to transmit queries, signals, messages, data, and requests between various entities, such as the database server 102, the application server 104, the driver device 106, the chatbot device 110, and/or the user device 112. Examples of the communication network 116 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the system environment 100 may be coupled to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the driver device 106 may be configured to generate the multilingual audio signal based on detection of sound uttered by the user 114 associated with the vehicle 108. For example, the driver device 106 may include one or more transducers (such as an audio transducer or a sound transducer) that are configured to detect the sound (uttered by the user 114 in the plurality of languages) and generate the multilingual audio signal. A common example of a transducer is a microphone. In another embodiment, the user device 112 may include the one or more transducers that are configured to detect the sound and generate the multilingual audio signal. In another embodiment, the chatbot device 110 may include the one or more transducers that are configured to detect the sound and generate the multilingual audio signal. In another embodiment, one or more standalone transducers (e.g., microphones) installed inside the vehicle 108 may be configured to detect the sound and generate the multilingual audio signal. The user 114 may be a passenger or a driver associated with the vehicle 108. In one example, the user 114 may be inside the vehicle 108. In another example, the user 114 may be within a predefined radial distance of the vehicle 108. The multilingual audio signal may be representation of audio or sound including one or more packets of words uttered by the user 114 using the plurality of languages. The multilingual audio signal may be represented in the form of an analog signal or a digital signal generated by the one or more transducers. In an embodiment, prior to the generation of the multilingual audio signal, the driver device 106, the chatbot device 110, the user device 112, or some other in-vehicle computing device may be configured to perform a check to determine an authenticity of the detected sound based on one or more users (such as the user 114) associated with the vehicle 108. In one example, the authenticity of the detected sound may be determined based on a current location of the user 114 (such as the driver of the vehicle 108 or the passenger inside the vehicle 108). For example, when the user 114 is within the predefined radial distance of the vehicle 108, the detected sound may be successfully authenticated. In another example, the authenticity of the detected sound may be determined based on an association of the user 114 with the vehicle 108. For example, when the user 114 is the driver of the vehicle 108, the detected sound may be successfully authenticated. Further, when the user 114 is the passenger of the vehicle 108, the detected sound may be successfully authenticated. Further, when the user 114 is inside the vehicle 108, the detected sound may be successfully authenticated. Upon successful authentication of the detected sound, the driver device 106, the chatbot device 110, the user device 112, or the one or more standalone transducers may generate the multilingual audio signal based on the detected sound.

In an embodiment, the driver device 106 may be further configured to transmit the multilingual audio signal to the application server 104 or the chatbot device 110. In another embodiment, the one or more standalone transducers may be configured to transmit the multilingual audio signal to the application server 104 or the chatbot device 110. In another embodiment, the chatbot device 110 may be configured to transmit the multilingual audio signal to the application server 104. In another embodiment, the user device 112 may be configured to transmit the multilingual audio signal to the application server 104. For the simplicity of the ongoing discussion, various operations associated with the intent detection have been described from the perspective of the application server 104. However, in some embodiments, the chatbot device 110 may perform the various operations associated with the intent detection without limiting the scope of the present disclosure.

In an embodiment, the application server 104 may be configured to receive the multilingual audio signal from the driver device 106, the one or more standalone transducers of the vehicle 108, the chatbot device 110, or the user device 112 via the communication network 116. The application server 104 may be further configured to convert the multilingual audio signal into the text component. The multilingual audio signal may be converted into the text component for each of the plurality of language transcripts. For example, in case of two language transcripts, the multilingual audio signal may be converted into a first text component corresponding to a first language transcript and a second text component corresponding to a second language transcript. In an embodiment, the plurality of language transcripts may be retrieved from the database server 102 defined by an administrator. In another embodiment, the plurality of language transcripts may be identified from the multilingual audio signal in real-time by the application server 104.

In an embodiment, the application server 104 may be further configured to generate the plurality of tokens corresponding to the text component of each of the plurality of language transcripts. For example, the application server 104 may generate a first plurality of tokens for the first text component and a second plurality of tokens for the second text component. The application server 104 may generate the plurality of tokens corresponding to each text component by performing text analysis using parsing and tokenization of each text component. In an embodiment, the application server 104 may be further configured to validate the plurality of tokens corresponding to each of the plurality of language transcripts and obtain a set of validated tokens. The plurality of tokens may be validated by using the language transcript dictionary retrieved from the database server 102. The language transcript dictionary may be retrieved from the database server 102 based on a language transcript associated with a plurality of tokens. In an exemplary embodiment, the first plurality of tokens (for example, associated with a Hindi language) may be validated using a first language transcript dictionary (such as a Hindi language dictionary) and the second plurality of tokens (for example, associated with a Kannada language) may be validated using a second language transcript dictionary (such as a Kannada language dictionary) to obtain the set of validated tokens.

In an embodiment, based on at least the set of validated tokens, the application server 104 may be further configured to determine at least one of the entity, keyword, and action features. An entity feature may be a word or a group of words indicative of a name of a specific thing or a set of things, such as living creatures, objects, places, or the like. A keyword feature may be a word or a group of words that serves as a key to the meaning of another word, passage, or sentence. The keyword feature may help to identify a specific content, document, characteristic, entity, or the like. An action feature may be a word or a group of words (e.g., verbs) that describes one or more actions associated with an entity, a keyword, or any combination thereof.

In an embodiment, the application server 104 may be further configured to generate a set of valid multilingual sentences based on at least the set of validated tokens and positional information of each validated token. The positional information of a validated token may indicate a most likely position of the validated token in a sentence of a respective language transcript. Further, the application server 104 may be configured to determine the entity feature based on the set of valid multilingual sentences and an entity index by using phonetic matching and prefix matching. The application server 104 may be further configured to determine the keyword and action features based on at least the set of validated tokens by using a filtration database including at least a set of validated entity, keyword, and action features for each stored intent. Upon determination of the entity, keyword, and action features corresponding to the multilingual audio signal, the application server 104 may store the determined entity, keyword, and action features in the database server 102.

In an embodiment, the application server 104 may be further configured to detect the one or more intents associated with the multilingual audio signal. The one or more intents may be detected based on at least one of the determined entity, keyword, and action features. The application server 104 may be further configured to determine the intent score for each detected intent based on at least one of the determined entity, keyword, and action features. For example, the intent score for each intent may be determined based on a frequency of usage or occurrence of at least one of the entity, keyword, and action features. Further, the application server 104 may be configured to select at least one intent from the one or more intents based on the intent score of each of the one or more intents. For example, at least one intent may be selected from the one or more intents based on the intent score of the at least one intent such that the intent score is greater than the intent score of each of remaining intents of the one or more intents. Further, the application server 104 may be configured to execute a user operation (i.e., an in-vehicle feature or service) requested by the user 114 based on the selected intent from the one or more intents. For example, if the selected intent corresponds to a request for playing a particular music of a particular singer inside the vehicle 108, then the application server 104 may retrieve the particular music of the particular singer from a music database and play the requested music in an online manner inside the vehicle 108. In another example, if the selected intent corresponds to a request for reducing AC temperature inside the vehicle 108, then the application server 104 may reduce the AC temperature inside the vehicle 108 in an online manner, or the application server 104 may communicate one or more control commands or instructions to the one or more in-vehicle devices or components of the HVAC system of the vehicle 108 for reducing the AC temperature inside the vehicle 108. Thus, by way of the detected intent of the user 114 from the multilingual audio signal, the application server 104 or the chatbot device 110 provides ease for monitoring, controlling, and operating infotainment system, HVAC system, door settings, window settings, safety equipment (e.g., airbag deployment control unit, collision sensor, nearby object sensing system, seat belt control unit, sensors for setting the seat belt, or the like), wireless network sensor (e.g., Wi-Fi or Bluetooth sensors), head lights, display panels, or the like.

FIG. 2 is a block diagram that illustrates the application server 104, in accordance with an exemplary embodiment of the disclosure. The application server 104 includes circuitry such as a natural language processor (NLP) 202. The natural language processor 202 includes circuitry such as an automatic speech recognition (ASR) processor 204, an entity detector 206, an action detector 208, a keyword detector 210, an intent detector 212, and an intent score calculator 214. The application server 104 further includes circuitry such as a recommendation engine 216, a memory 218, and a transceiver 220. The natural language processor 202, the recommendation engine 216, the memory 218, and the transceiver 220 may communicate with each other via a communication bus (not shown).

The natural language processor 202 may include suitable logic, circuitry, interfaces, and/or code, executable by the circuitry, that may be configured to perform the one or more operations associated with the intent detection. The natural language processor 202 may be implemented by one or more processors, such as, but are not limited to, an application-specific integrated circuit (ASIC) processor, a reduced instruction set computing (RISC) processor, a complex instruction set computing (CISC) processor, and a field-programmable gate array (FPGA). The one or more processors may also correspond to central processing units (CPUs), graphics processing units (GPUs), network processing units (NPUs), digital signal processors (DSPs), or the like. In some embodiments, the natural language processor 202 may include a machine-learning model that implements any suitable machine-learning techniques, statistical techniques, or probabilistic techniques for performing the one or more operations. It will be apparent to a person skilled in the art that the natural language processor 202 may be compatible with multiple operating systems.

In an embodiment, the natural language processor 202 may be configured to control and manage pre-processing of the multilingual audio signal by using the ASR processor 204. The pre-processing of the multilingual audio signal may include converting the multilingual audio signal into one or more text components, generating one or more tokens for each text component, validating the one or more tokens to obtain one or more validated tokens, and generating one or more valid multilingual sentences. The natural language processor 202 may be further configured to control and manage extraction or determination of one or more entity features by using the entity detector 206. The natural language processor 202 may be further configured to control and manage extraction or determination of one or more action features by using the action detector 208. The natural language processor 202 may be further configured to control and manage extraction of one or more keyword features by using the keyword detector 210. The natural language processor 202 may be further configured to control and manage detection of the one or more intents corresponding to the multilingual audio signal by using the intent detector 212. The natural language processor 202 may be further configured to control and manage calculation of one or more intent scores corresponding to the one or more intents by using the intent score calculator 214.

In an embodiment, the natural language processor 202 may be configured to operate as a master processing unit, and each of the ASR processor 204, the entity detector 206, the action detector 208, the keyword detector 210, the intent detector 212, and the intent score calculator 214 may be configured to operate as a slave processing unit. In such a scenario, the natural language processor 202 may be configured to generate and communicate one or more instructions or control commands to the ASR processor 204, the entity detector 206, the action detector 208, the keyword detector 210, the intent detector 212, and the intent score calculator 214 to perform their corresponding operations either independently or in conjunction with each other.

The ASR processor 204 may include suitable logic, circuitry, interfaces, and/or code, executable by the circuitry, that may be configured to perform one or more pre-processing operations associated with the intent detection. For example, the ASR processor 204 may be configured to covert the multilingual audio signal into the one or more text components and store the one or more text components in the memory 218. The one or more text components may correspond to one or more language transcripts, respectively. The one or more language transcripts may be determined or identified based on one or more languages (used by the user 114) associated with the multilingual audio signal. The ASR processor 204 may be further configured to generate the one or more tokens for each text component of each language transcript and store the one or more tokens in the memory 218. The ASR processor 204 may be further configured to validate the one or more tokens to obtain the one or more validated tokens and store the one or more validated tokens in the memory 218. The one or more tokens may be validated by using the language transcript dictionary associated with the respective language transcript. The ASR processor 204 may be further configured to generate the one or more valid multilingual sentences and store the one or more valid multilingual sentences in the memory 218. The one or more valid multilingual sentences may be generated based on the one or more validated tokens and the positional information of each validated token. The ASR processor 204 may be implemented by one or more processors, such as, but are not limited to, an ASIC processor, a RISC processor, a CISC processor, and an FPGA.

The entity detector 206 may include suitable logic, circuitry, interfaces, and/or code, executable by the circuitry, that may be configured to perform one or more operations associated with the entity determination. For example, the entity detector 206 may be configured to determine the one or more entity features, for example, a singer name, a movie name, an individual name, a place name, or the like, and store the one or more entity features in the memory 218. The one or more entity features may be determined from the multilingual audio signal. In one example, the one or more entity features may be determined based on at least the one or more validated tokens. In a specific example, the one or more entity features may be determined based on at least the one or more valid multilingual sentences and the entity index by using phonetic matching and prefix matching. The entity detector 206 may determine an entity feature by matching an entity name with a respective identifier. The identifier may be linked to an entity node in a knowledge graph that includes information of the one or more entities. The one or more entities may correspond to at least one or more popular places, names, movies, songs, locations, organizations, institutions, establishments, websites, applications, or the like. The entity detector 206 may be implemented by one or more processors, such as, but are not limited to, an ASIC processor, a RISC processor, a CISC processor, and an FPGA.

The action detector 208 may include suitable logic, circuitry, interfaces, and/or code, executable by the circuitry, that may be configured to perform one or more operations associated with the action determination. For example, the action detector 208 may be configured to determine the one or more action features from the multilingual audio signal and store the one or more action features in the memory 218. In one example, the action detector 208 may determine the one or more action features based on at least the one or more validated tokens by using the filtration database including at least the set of validated entity, keyword, and action features for each stored intent. In another example, the action detector 208 may be configured to receive the one or more valid multilingual sentences corresponding to the multilingual audio signal from the ASR processor 204. The action detector 208 may further determine the one or more action features from the one or more valid multilingual sentences. An action feature may correspond to an act, a command, or a request for imitating or executing one or more in-vehicle operations. The action detector 208 may be implemented by one or more processors, such as, but are not limited to, an ASIC processor, a RISC processor, a CISC processor, and an FPGA.

The keyword detector 210 may include suitable logic, circuitry, interfaces, and/or code, executable by the circuitry, that may be configured to perform one or more operations associated with the keyword determination. For example, the keyword detector 210 may be configured to determine the one or more keyword features from the multilingual audio signal and store the one or more keyword features in the memory 218. In one example, the keyword detector 210 may determine the one or more keyword features based on at least the one or more validated tokens by using the filtration database including at least the set of validated entity, keyword, and action features for each stored intent. In another example, the keyword detector 210 may be configured to receive the one or more valid multilingual sentences corresponding to the multilingual audio signal from the ASR processor 204. The keyword detector 210 may further determine the one or more keyword features from the one or more valid multilingual sentences. A keyword may correspond to a song, movie, temperature, or the like. The keyword detector 210 may be implemented by one or more processors, such as, but are not limited to, an ASIC processor, a RISC processor, a CISC processor, and an FPGA.

The intent detector 212 may include suitable logic, circuitry, interfaces, and/or code, executable by the circuitry, that may be configured to execute one or more operations associated with the intent detection. For example, the intent detector 212 may be configured to detect or determine the one or more intents of the user 114 from the multilingual audio signal corresponding to the sound uttered by the user 114. The intent detector 212 may detect the one or more intents based on at least one of the one or more entity, keyword, and action features. An intent may correspond to one of play, pause, resume, or stop music or video streaming in the vehicle 108. An intent may correspond to increase or decrease of the in-vehicle AC temperature. An intent may correspond to increase or decrease of volume, or the like. Other intents may include managing and controlling door settings, window settings, safety equipment (e.g., airbag deployment control unit, collision sensor, nearby object sensing system, seat belt control unit, sensors for setting the seat belt, or the like), wireless network sensor (e.g., Wi-Fi or Bluetooth sensors), head lights, display panels, or the like. The intent detector 212 may be implemented by one or more processors, such as, but are not limited to, an ASIC processor, a RISC processor, a CISC processor, and an FPGA.

The intent score calculator 214 may include suitable logic, circuitry, interfaces, and/or code, executable by the circuitry, that may be configured to perform one or more operations associated with the calculation of the one or more intent scores corresponding to the one or more intents, respectively. For example, the intent score calculator 214 may be configured to calculate an intent score for a detected intent based on at least one of the one or more entity, keyword, and action features. An intent with a highest intent score may be selected form the one or more intents. Thereafter, based on the selected intent, the one or more in-vehicle operations may be automatically initiated or executed inside the vehicle 108. The intent score calculator 214 may be implemented by one or more processors, such as, but are not limited to, an ASIC processor, a RISC processor, a CISC processor, and an FPGA.

The recommendation engine 216 may include suitable logic, circuitry, interfaces, and/or code, executable by the circuitry, that may be configured to perform one or more recommendation operations. For example, the recommendation engine 216 may be configured to identify and recommend the one or more in-vehicle operations, features, or services to the user 114 based on the detected intent from the multilingual audio signal. In case of unavailability of the one or more in-vehicle operations, features, or services, the recommendation engine 216 may identify and recommend other in-vehicle operations, features, or services that are related (i.e., closest match) to the detected intent. Upon confirmation of at least one of the other in-vehicle operations, features, or services by the user 114, the recommendation engine 216 may initiate or execute the related operation in real-time. The recommendation engine 216 may be implemented by one or more processors, such as, but are not limited to, an ASIC processor, a RISC processor, a CISC processor, and an FPGA.

The memory 218 may include suitable logic, circuitry, interfaces, and/or code, executable by the circuitry, that may be configured to store one or more instructions that are executed by the natural language processor 202, the ASR processor 204, the entity detector 206, the action detector 208, the keyword detector 210, the intent detector 212, the intent score calculator 214, the recommendation engine 216, and the transceiver 220 to perform their operations. The memory 218 may be configured to temporarily store and manage the historical audio signals, the real-time audio signal (i.e., the multilingual audio signal), the intent information, or the entity, keyword, and action information. The memory 218 may be further configured to temporarily store and manage the one or more text components, the one or more tokens, the one or more validated tokens, the one or more valid multilingual sentences, or the like. The memory 218 may be further configured to temporarily store and manage a set of previously selected intents, and one or more previous recommendations based on the set of previously selected intents. Examples of the memory 218 may include, but are not limited to, a random-access memory (RAM), a read-only memory (ROM), a programmable ROM (PROM), and an erasable PROM (EPROM).

The transceiver 220 may include suitable logic, circuitry, interfaces, and/or code, executable by the circuitry, that may be configured to transmit (or receive) data to (or from) various servers or devices, such as the database server 102, the driver device 106, the chatbot device 110, or the user device 112 via the communication network 116. Examples of the transceiver 220 may include, but are not limited to, an antenna, a radio frequency transceiver, a wireless transceiver, and a Bluetooth transceiver. The transceiver 220 may be configured to communicate with the database server 102, the driver device 106, the chatbot device 110, or the user device 112 using various wired and wireless communication protocols, such as TCP/IP, UDP, LTE communication protocols, or any combination thereof.

FIG. 3 is a block diagram that illustrates the chatbot device 110, in accordance with an exemplary embodiment of the disclosure. The chatbot device 110 includes circuitry such as a natural language processor (NLP) 302. The natural language processor 302 includes circuitry such as an ASR processor 304, an entity detector 306, an action detector 308, a keyword detector 310, an intent detector 312, and an intent score calculator 314. The chatbot device 110 further includes circuitry such as a recommendation engine 316, a memory 318, and a transceiver 320. The natural language processor 302, the recommendation engine 316, the memory 318, and the transceiver 320 may communicate with each other via a communication bus (not shown). Functionalities and operations of various components of the chatbot device 110 may be similar to the functionalities and operations of the various components of the application server 104 as described above in conjunction with FIG. 2.

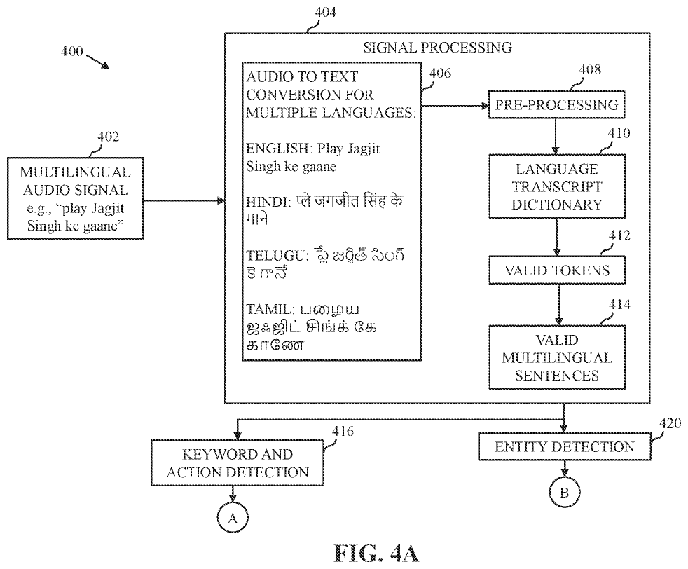

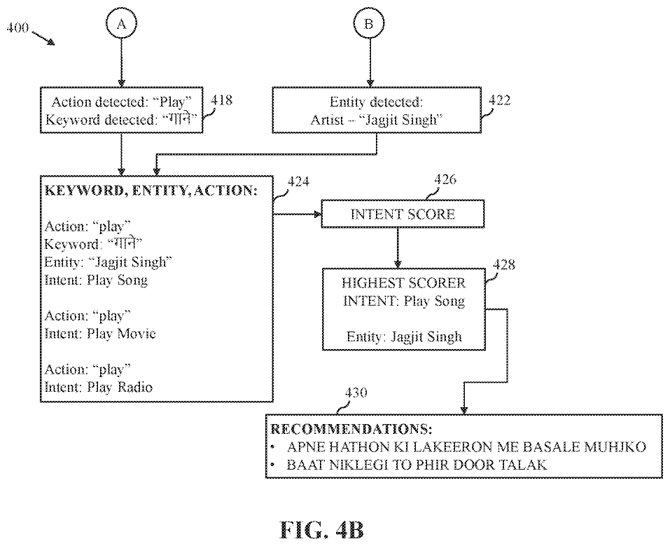

FIGS. 4A and 4B, collectively, is a block diagram that illustrate an exemplary scenario 400 for the intent detection from the multilingual audio signal, in accordance with an exemplary embodiment of the disclosure.

The application server 104 (or the chatbot device 110) may be configured to detect or generate the multilingual audio signal (as shown by 402) based on the sound uttered by the user 114. Alternatively, the application server 104 (or the chatbot device 110) may receive the multilingual audio signal from the driver device 106, the one or more standalone transducers of the vehicle 108, or the user device 112 via the communication network 116. The multilingual audio signal, in one example, may correspond to “play Jagjit Singh ke gaane.” In the ongoing example, the multilingual audio signal includes a plurality of words from a plurality of languages. Here, the multilingual audio signal is a combination of the plurality of words such as Hindi and English words from the plurality of languages such as Hindi and English languages. Further, the application server 104 (or the chatbot device 110) may be configured to perform signal processing (as shown by 404). The signal processing may be performed based on the detected multilingual audio signal. The application server 104 (or the chatbot device 110) may be further configured to perform audio to text conversion for multiple languages associated with the multilingual audio signal (as shown by 406). The multilingual audio signal may be converted into the text component of each of the plurality of language transcripts such as Hindi language transcript, English language transcript, Telugu language transcript, and Tamil language transcript as shown in FIG. 4A. For example, the multilingual audio signal has been converted into a text component of different languages such as in English “play Jagjit Singh ke gaane,” in Hindi “ [symbol] ” in Telugu “ [symbol] , ” and in Tamil “ [symbol] [symbol] .”

Further, the application server 104 (or the chatbot device 110) may be configured to perform pre-processing of each text component obtained in the plurality of language transcripts such as Hindi language transcript, English language transcript, Telugu language transcript, and Tamil language transcript (as shown by 408). The pre-processing may include generating the plurality of tokens corresponding to the text component of each of the plurality of language transcripts. For example, the application server 104 (or the chatbot device 110) may generate a first plurality of tokens for the English text component, a second plurality of tokens for the Hindi text component, a third plurality of tokens for the Telugu text component, and a fourth plurality of tokens for the Tamil text component.

Further, the application server 104 (or the chatbot device 110) may be configured to retrieve the language transcript dictionary corresponding to each of the plurality of language transcripts from the database server 102 (as shown by 410). The application server 104 (or the chatbot device 110) may be further configured to validate the plurality of tokens corresponding to each of the plurality of language transcripts and obtain the set of validated tokens (as shown by 412). The plurality of tokens may be validated by using the language transcript dictionary retrieved from the database server 102. The language transcript dictionary may be retrieved from the database server 102 based on a language transcript associated with the plurality of tokens. For example, the first plurality of tokens (associated with the English language) may be validated using a first language transcript dictionary (such as an English language dictionary), the second plurality of tokens (associated with the Hindi language) may be validated using a second language transcript dictionary (such as a Hindi language dictionary), the third plurality of tokens (associated with the Telugu language) may be validated using a third language transcript dictionary (such as a Telugu language dictionary), and the fourth plurality of tokens (associated with the Tamil language) may be validated using a fourth language transcript dictionary (such as a Tamil language dictionary) to obtain the set of validated tokens.

Further, the application server 104 (or the chatbot device 110) may be configured to generate the set of valid multilingual sentences (as shown by 414). The set of valid multilingual sentences may be generated based on at least the set of validated tokens and the positional information of each validated token. The positional information of each validated token may be obtained from the database server 102. The application server 104 (or the chatbot device 110) may be further configured to perform keyword and action detection (as shown by 416). In the process of the keyword and action detection, the application server 104 (or the chatbot device 110) may determine the keyword and action features based on at least one of the set of validated tokens or the set of valid multilingual sentences by using the filtration database including at least the set of validated entity, keyword, and action features for each stored intent. Here, a comparison check of each validated token in each valid multilingual sentence may be performed with the validated keyword feature in the filtration database. When the comparison check is successful, the validated token may be identified as a keyword feature. Similarly, a comparison check of each validated token in each valid multilingual sentence may be performed with the validated action feature in the filtration database. When the comparison check is successful, the validated token may be identified as an action feature. For example, by executing the keyword and action detection process, the application server 104 (or the chatbot device 110) detects “play” as an action feature and “ [symbol] ” as a keyword feature (as shown by 418).

Further, the application server 104 (or the chatbot device 110) may be configured to perform entity detection (as shown by 420). The entity detection may be performed by using the entity index (i.e., a reverse index of entity names and their respective identifiers). These identifiers point to one or more entity nodes in the knowledge graph which includes all the information about the various entities. Further, the entity feature matching may be performed by using the phonetic matching with fuzziness along with ensuring the prefix matching. Thus, in the process of the entity detection, the application server 104 (or the chatbot device 110) may determine the entity feature based on the set of valid multilingual sentences and the entity index by using the phonetic matching and the prefix matching. For example, by executing the entity detection process, the application server 104 (or the chatbot device 110) detects “Jagjit Singh” as an entity feature (as shown by 422).

Further, the application server 104 (or the chatbot device 110) may be configured to detect the one or more intents based on at least one of the entity, keyword, and action features detected from the multilingual audio signal (as shown by 424). As shown at 424, the one or more detected intents include “Play Song,” “Play Movie,” and “Play Radio.” The application server 104 (or the chatbot device 110) may be further configured to determine an intent score for each of the one or more detected intents (as shown by 426). The intent score for each detected intent may be determined based on at least one of the determined entity, keyword, and action features. For example, the intent score for each intent may be determined based on a frequency of usage or occurrence of at least one of the entity, keyword, and action features. Further, the application server 104 (or the chatbot device 110) may be configured to select at least one intent from the one or more detected intents based on the intent score of each of the one or more detected intents. For example, at least one intent may be selected from the one or more detected intents such that the intent score of the at least one selected intent is greater than the intent scores of remaining intents. Further, the intent “Play Song” is selected from the intents “Play Song,” “Play Movie,” and “Play Radio” (as shown by 428). Further, at 428, the entity feature “Jagjit Singh” associated with the selected intent “Play Song” is also shown.

Further, the application server 104 (or the chatbot device 110) may be configured to present one or more recommendations of one or more songs associated with the determined entity “Jagjit Singh” to the user 114 who has initiated the request (as shown by 430). The one or more recommendations may be presented in an audio form, a visual form, or any combination thereof. Based on the presented recommendations of the one or more songs, the user 114 may select one song that is played by the application server 104 (or the chatbot device 110).

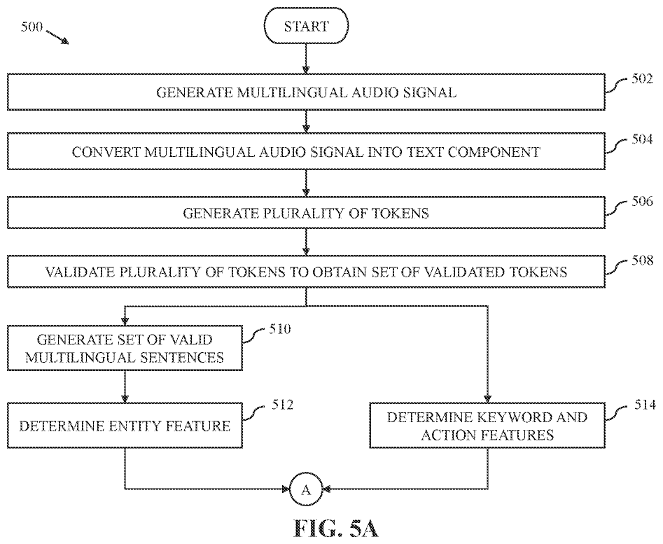

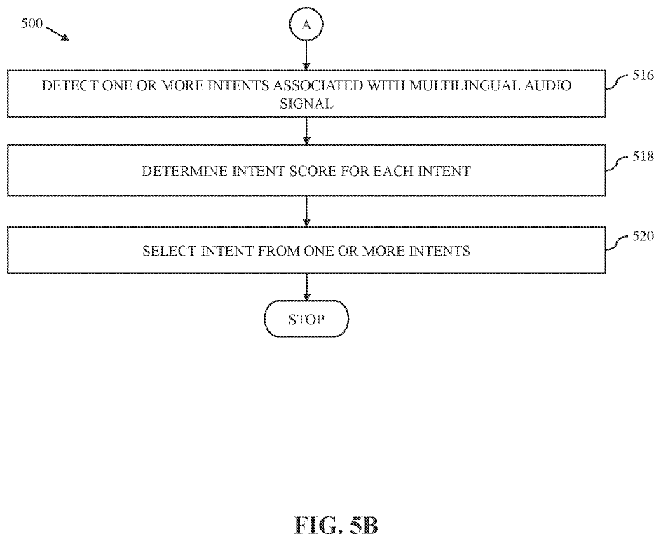

FIGS. 5A and 5B, collectively, is a diagram that illustrates a flow chart 500 of a method for detecting an intent from the multilingual audio signal, in accordance with an exemplary embodiment of the disclosure.

At 502, the multilingual audio signal is generated. In an embodiment, the application server 104 (or the chatbot device 110) may be configured to generate the multilingual audio signal. The multilingual audio signal may be generated based on detection of the sound uttered by the user 114 associated with the vehicle 108.

At 504, the multilingual audio signal is converted into a text component. In an embodiment, the application server 104 (or the chatbot device 110) may be further configured to convert the multilingual audio signal into the text component. The multilingual audio signal may be converted into the text component corresponding to each of the plurality of language transcripts.

At 506, the plurality of tokens is generated. In an embodiment, the application server 104 (or the chatbot device 110) may be further configured to generate the plurality of tokens corresponding to the text component of each of the plurality of language transcripts.

At 508, the plurality of tokens is validated to obtain the set of validated tokens. In an embodiment, the application server 104 (or the chatbot device 110) may be further configured to validate the plurality of tokens corresponding to each of the plurality of language transcripts and obtain the set of validated tokens. The plurality of tokens may be validated by using the language transcript dictionary retrieved from the database server 102.

At 510, the set of valid multilingual sentences may be generated. In an embodiment, the application server 104 (or the chatbot device 110) may be further configured to generate the set of valid multilingual sentences based on at least the set of validated tokens and the positional information of each validated token.

At 512, the entity feature is determined. In an embodiment, the application server 104 (or the chatbot device 110) may be further configured to determine the entity feature based on the set of valid multilingual sentences and the entity index by using the phonetic matching and the prefix matching.

At 514, the keyword and action features are determined. In an embodiment, the application server 104 (or the chatbot device 110) may be further configured to determine the keyword and action features based on at least the set of validated tokens by using the filtration database including at least the set of validated entity, keyword, and action features for each stored intent.

At 516, the one or more intents associated with the multilingual audio signal are detected. In an embodiment, the application server 104 (or the chatbot device 110) may be further configured to detect the one or more intents based on at least one of the determined entity, keyword, and action features.

At 518, the intent score for each detected intent is determined. In an embodiment, the application server 104 (or the chatbot device 110) may be further configured to determine the intent score for each detected intent based on at least one of the determined entity, keyword, and action features.

At 520, at least one intent is selected from the one or more detected intents. In an embodiment, the application server 104 (or the chatbot device 110) may be further configured to select the at least one intent from the one or more detected intents based on the intent score of each of the one or more detected intents. For example, the at least one intent may be selected from the one or more detected intents such that the intent score of the at least one selected is greater than the intent score of each of remaining intents of the one or more detected intents.

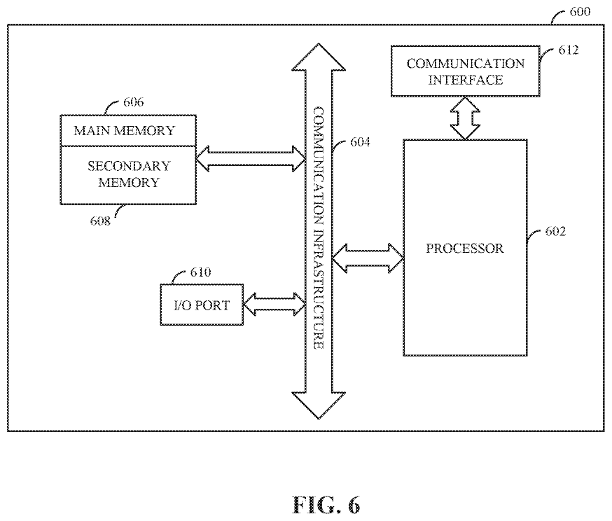

FIG. 6 is a block diagram that illustrates a system architecture of a computer system 600 for detecting the intent from the multilingual audio signal, in accordance with an exemplary embodiment of the disclosure. An embodiment of the disclosure, or portions thereof, may be implemented as computer readable code on the computer system 600. In one example, the database server 102, the application server 104, or the chatbot device 110 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIG. 5.

The computer system 600 may include a processor 602 that may be a special purpose or a general-purpose processing device. The processor 602 may be a single processor, multiple processors, or combinations thereof. The processor 602 may have one or more processor “cores.” Further, the processor 602 may be coupled to a communication infrastructure 604, such as a bus, a bridge, a message queue, multi-core message-passing scheme, the communication network 116, or the like. The computer system 600 may further include a main memory 606 and a secondary memory 608. Examples of the main memory 606 may include RAM, ROM, and the like. The secondary memory 608 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 600 may further include an input/output (I/O) port 610 and a communication interface 612. The I/O port 610 may include various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communication port, and the like. Data transferred via the communication interface 612 may be signals, such as electronic, electromagnetic, optical, or other signals as will be apparent to a person skilled in the art. The signals may travel via a communications channel, such as the communication network 116, which may be configured to transmit the signals to the various devices that are communicatively coupled to the computer system 600. Examples of the communication channel may include a wired, wireless, and/or optical medium such as cable, fiber optics, a phone line, a cellular phone link, a radio frequency link, and the like. The main memory 606 and the secondary memory 608 may refer to non-transitory computer readable mediums that may provide data that enables the computer system 600 to implement the method illustrated in FIG. 5.

Various embodiments of the disclosure provide the application server 104 (or the chatbot device 110) for detecting user's intent. The application server 104 (or the chatbot device 110) may be configured to generate a multilingual audio signal based on utterance by the user 114 to initiate an operation. The utterance may be associated with a plurality of languages. The application server 104 (or the chatbot device 110) may be further configured to convert, for each of a plurality of language transcripts corresponding to the plurality of languages, the multilingual audio signal into a text component. The application server 104 (or the chatbot device 110) may be further configured to generate, for the text component of each of the plurality of language transcripts, a plurality of tokens. The application server 104 (or the chatbot device 110) may be further configured to validate the plurality of tokens corresponding to each of the plurality of language transcripts using a language transcript dictionary associated with a respective language transcript. The plurality of tokens may be validated to obtain a set of validated tokens. The application server 104 (or the chatbot device 110) may be further configured to determine at least entity, keyword, and action features based on at least the set of validated tokens. The application server 104 (or the chatbot device 110) may be further configured to detect one or more intents based on at least the determined entity, keyword, and action features. Thereafter, the requested operation is automatically executed based on an intent from the one or more intents.

Various embodiments of the disclosure provide a non-transitory computer readable medium having stored thereon, computer executable instructions, which when executed by a computer, cause the computer to execute operations for detecting user's intent. The operations include generating, by the application server 104 (or the chatbot device 110), a multilingual audio signal based on utterance by the user 114 in the vehicle 108 to initiate an in-vehicle operation. The utterance may be associated with a plurality of languages. The operations further include converting, by the application server 104 (or the chatbot device 110), for each of a plurality of language transcripts corresponding to the plurality of languages, the multilingual audio signal into a text component. The operations further include generating, by the application server 104 (or the chatbot device 110), for the text component of each of the plurality of language transcripts, a plurality of tokens. The operations further include validating, by the application server 104 (or the chatbot device 110), the plurality of tokens corresponding to each of the plurality of language transcripts using a language transcript dictionary associated with a respective language transcript. The plurality of tokens may be validated to obtain a set of validated tokens. The operations further include determining, by the application server 104 (or the chatbot device 110), at least entity, keyword, and action features based on at least the set of validated tokens. The operations further include detecting, by the application server 104 (or the chatbot device 110), one or more intents based on at least the determined entity, keyword, and action features, wherein the in-vehicle operation is automatically executed based on an intent from the one or more intents.

The disclosed embodiments encompass numerous advantages. The user's intent is determined from the multilingual audio signal. Such intent detection supports international as well as regional languages. So, it becomes easy and efficient to use such intent detection for different scenarios and is not limited to any geographical boundaries. Such user's intent detection has the advantage of being less time-consuming and less efforts are required by developers. As there is no need to prepare language transcripts for every different language, the language transcripts are readily available from other different sources. Also, there is no need to prepare any training model for every language so it can be used for as many languages as required. Further, the user's intent detection does not require to use and prepare its own ASR, any pre-existing third-party ASR may be used. This makes the system economical as there is no need to prepare a separate multilingual speech recognition system. Such intent detection can be used anywhere including public places, vehicles, or the like. Thus, the disclosure provides an efficient way of detecting the user's intent. The disclosed embodiments encompass other advantages. For example, the disclosure provides the ease for controlling the in-vehicle infotainment system and, features related to heating, ventilation, and air conditioning (HVAC) of the vehicle in any language. Furthermore, with such intent detection, there may not be need of any separate language translating system.

A person of ordinary skill in the art will appreciate that embodiments and exemplary scenarios of the disclosed subject matter may be practiced with various computer system configurations, including multi-core multiprocessor systems, minicomputers, and mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the disclosure provide, among other features, systems and methods for detecting user's intent from a multilingual audio signal associated with a plurality of languages. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method, comprising:
generating, by a natural language processor (NLP), a multilingual audio signal based on utterance by a user in a vehicle to initiate an in-vehicle operation, wherein the utterance is associated with a plurality of languages;
converting, by the NLP, for each of a plurality of language transcripts corresponding to the plurality of languages, the multilingual audio signal into a text component;
generating, by the NLP, for the text component of each of the plurality of language transcripts, a plurality of tokens;
validating, by the NLP, the plurality of tokens corresponding to each of the plurality of language transcripts using a language transcript dictionary associated with a respective language transcript, wherein the plurality of tokens is validated to obtain a set of validated tokens;
determining, by the NLP, at least entity, keyword, and action features based on at least the set of validated tokens; and
detecting, by the NLP, one or more intents based on at least the determined entity, keyword, and action features, wherein the in-vehicle operation is automatically executed based on an intent from the one or more intents.

2. The method of claim 1, further comprising generating, by the NLP, a set of valid multilingual sentences based on the set of validated tokens.

3. The method of claim 2, wherein the entity feature is further determined based on the set of valid multilingual sentences.

4. The method of claim 1, wherein the keyword and action features are further determined based on the set of validated tokens by using a filtration database including at least a set of validated entity, keyword, and action features for each stored intent.

5. The method of claim 1, further comprising determining, by the NLP, an intent score for each intent based on at least the determined entity, keyword, and action features.

6. The method of claim 5, further comprising selecting, by the NLP, the intent from the one or more intents based on the intent score of each of the one or more intents, wherein the intent score of the selected intent is greater than the intent score of each of remaining intents of the one or more intents.

7. A system, comprising:
a natural language processor (NLP) configured to:
generate a multilingual audio signal based on utterance by a user to initiate an operation, wherein the utterance is associated with a plurality of languages;
convert, for each of a plurality of language transcripts that corresponds to the plurality of languages, the multilingual audio signal into a text component;
generate, for the text component of each of the plurality of language transcripts, a plurality of tokens;
validate the plurality of tokens that corresponds to each of the plurality of language transcripts by use of a language transcript dictionary associated with a respective language transcript, wherein the plurality of tokens is validated to obtain a set of validated tokens;
determine at least entity, keyword, and action features based on at least the set of validated tokens; and
detect one or more intents based on at least the determined entity, keyword, and action features, wherein the operation is automatically executed based on an intent from the one or more intents.

8. The system of claim 7, wherein the NLP is further configured to generate a set of valid multilingual sentences based on the set of validated tokens.

9. The system of claim 8, wherein the NLP is further configured to determine the entity feature based on the set of valid multilingual sentences.

10. The system of claim 7, wherein the NLP is further configured to determine the keyword and action features based on the set of validated tokens by use of a filtration database that includes at least a set of validated entity, keyword, and action features for each stored intent.

11. The system of claim 7, wherein the NLP is further configured to determine an intent score for each intent based on at least the determined entity, keyword, and action features.

12. The system of claim 11, wherein the NLP is further configured to select the intent from the one or more intents based on the intent score of each of the one or more intents, and wherein the intent score of the selected intent is greater than the intent score of each of remaining intents of the one or more intents.

13. A vehicle chatbot device, comprising:
a natural language processor (NLP) configured to:
generate a multilingual audio signal based on utterance by a user in a vehicle to initiate an in-vehicle operation, wherein the utterance is associated with a plurality of languages;
convert, for each of a plurality of language transcripts that corresponds to the plurality of languages, the multilingual audio signal into a text component;
generate, for the text component of each of the plurality of language transcripts, a plurality of tokens;
validate the plurality of tokens that corresponds to each of the plurality of language transcripts by use of a language transcript dictionary associated with a respective language transcript, wherein the plurality of tokens is validated to obtain a set of validated tokens;
determine at least entity, keyword, and action features based on at least the set of validated tokens; and
detect one or more intents based on at least the determined entity, keyword, and action features, wherein the in-vehicle operation is automatically executed based on an intent from the one or more intents.

14. The vehicle chatbot device of claim 13, wherein the NLP is further configured to generate a set of valid multilingual sentences based on the set of validated tokens.

15. The vehicle chatbot device of claim 14, wherein the NLP is further configured to determine the entity feature based on the set of valid multilingual sentences.

16. The vehicle chatbot device of claim 13, wherein the NLP is further configured to determine the keyword and action features based on the set of validated tokens by use of a filtration database that includes at least a set of validated entity, keyword, and action features for each stored intent.

17. The vehicle chatbot device of claim 13, wherein the NLP is further configured to determine an intent score for each intent based on at least the determined entity, keyword, and action features.

18. The vehicle chatbot device of claim 17, wherein the NLP is further configured to select the intent from the one or more intents based on the intent score of each of the one or more intents, and wherein the intent score of the selected intent is greater than the intent score of each of remaining intents of the one or more intents.
